(19) United States
(12) Patent Application Publication
(10) Pub. No.: US 2021/0273787 A1
(43) Pub. Date: Sep. 2, 2021

(54) AUTOMATIC BARGAINING METHOD AND RELATED DEVICE BASED ON SMART CONTRACT AND SECURE MULTI-PARTY COMPUTATION

(71) Applicant: GUANGDONG UNIVERSITY OF TECHNOLOGY, GUANGZHOU (CN)

(72) Inventors: Jiewu LENG, GUANGZHOU (CN); Wenshun DENG, GUANGZHOU (CN); Qiang LIU, GUANGZHOU (CN); Guolei RUAN, GUANGZHOU (CN); Hu ZHANG, GUANGZHOU (CN); Jianbo JING, GUANGZHOU (CN); Shide YE, GUANGZHOU (CN)

(21) Appl. No.: 17/060,168

(22) Filed: Oct. 1, 2020

(30) Foreign Application Priority Data
Feb. 28, 2020 (CN) 202010129417.3

(51) Int. Cl. H04L 9/08; H04L 9/00; H04L 9/14; G06Q 20/38

(52) U.S. Cl. CPC H04L 9/0825; H04L 9/008; H04L 9/14; G06Q 2220/00; H04L 2209/466; H04L 2209/56; G06Q 20/382

(57) ABSTRACT

Disclosed is a smart contract and an automatic bargaining method for secure multi-party computation and a device embodies same. A first public key and a first private key are generated based on a homomorphic encryption algorithm in the smart contract, the first public key is sent to a demander and a supplier so that the demander and the supplier encrypt the purchase price and the sale price through the first public key, respectively; after receiving a second public key and an encrypted purchase price sent by the demander and a third public key and an encrypted sale price sent by the supplier, the encrypted sale price and the encrypted purchase price that meet the preset transaction conditions are decrypted.

### CROSS-REFERENCE TO RELATED APPLICATIONS

This application claims priority to Chinese Patent Application No. 202010129417.3 with a filing date of Feb. 28, 2020. The content of the aforementioned applications, including any intervening amendments thereto, are incorporated herein by reference.

### TECHNICAL FIELD

The present application relates to the field of information security technology, and more specifically, to an automatic bargaining method and related devices based on smart contract and secure multi-party computation.

### BACKGROUND

In the supply chain, the relationship between the demander and the supplier is usually divided into two categories. One relationship is that the demander dominates, that is, when the supplier is in a low value-added industry, a plurality of suppliers provide services to one demander, and the industry threshold is low and the competition is fierce; the other relationship is that the supplier dominates, that is, the supplier has core technology to provide services to the demander, and the demander relies on its technology and cannot find suitable substitutes, such as the chip industry.

Take traditional low value-added industries as an example. In general, the demander is in a dominant position and the supplier is in a passive position. Therefore, in the price negotiation stage, the demander will quote a lower purchase price and the supplier will first quote a higher sale price. In previous negotiations, both parties had negotiated several times to reach a coordination, but a lot of time, manpower, and material resources would be wasted in this process. At the same time, both parties are reluctant to disclose their information before the transaction is concluded. Because for a supplier in a passive position, production costs and sale prices are his bargaining weights in the supply chain, he is unwilling to share directly with the demander. At the same time, he is worried that this information will be obtained by competitors in the negotiation process, thereby reducing their competitiveness in front of peers. In order to reduce his own costs, the demander is unwilling to quote his own price at once, but demands a lower price on this basis, so as to obtain the greatest benefit. Therefore, the protection of privacy information of both parties is an important aspect in the negotiation process.

Most of the existing bargaining methods focus on the realization of bargaining solutions, usually on the realization of online bargaining platforms. Users can negotiate prices online and determine the transaction results. Although the convenience and efficiency of both parties are improved, due to the characteristics of the Internet, the price information of both parties is likely to be leaked in the process of propagation, and there is a problem of lack of protecting the data privacy of both bargaining parties.

### SUMMARY

The present application provides an automatic bargaining method for secure multi-party computation based on smart contract and secure multi-party computation and a related device, solving the technical problem that the existing bargaining method is in lack of protecting the data privacy of both bargaining parties.

In view of this, the first aspect of the present application provides an automatic bargaining method based on smart contract and secure multi-party computation, comprising:

generating a first public key and a first private key based on a homomorphic encryption algorithm in the smart contract;

sending the first public key to a demander and a supplier so that the demander encrypts the purchase price through the first public key to obtain the encrypted purchase price, and the supplier encrypts the sale price through the first public key to obtain the encrypted sale price;

after receiving a second public key and the encrypted purchase price sent by the demander and a third public key and the encrypted sale price sent by the supplier, decrypting the encrypted sale price and the encrypted purchase price that meet the preset transaction conditions based on the smart contract through the first private key to obtain the corresponding sale price and the purchase price;

determining the pricing based on a preset pricing strategy of the smart contract, encrypting the pricing through the second public key to obtain a first encrypted pricing, and encrypting the pricing through the third public key to obtain a second encrypted pricing; and

sending the first encrypted pricing to the demander, and sending the second encrypted pricing to the supplier, so that the demander and the supplier obtain the pricing after corresponding decryption.

Preferably, the preset pricing strategy is as follows:

when the purchase price is less than the sale price and the difference between the sale price and the purchase price is less than a preset threshold, the pricing is as follows:

$$c = \frac{{m}_{1} a + {m}_{2} b}{{m}_{1} + {m}_{2}} ;$$

where a and b are the purchase price and the sale price, respectively, m 1 and m 2 are the weight coefficients of a and b, respectively, and c is the pricing;

when the purchase price is greater than or equal to the sale price and the demander dominates the transaction, the sale price is taken as the pricing, wherein the transaction situation corresponding to the demander dominating the transaction is one demander and a plurality of suppliers;

when the purchase price is greater than or equal to the sale price and the supplier dominates the transaction, the purchase price is taken as the pricing, wherein the transaction situation corresponding to the supplier dominating the transaction is one supplier and a plurality of demanders.

Preferably, after receiving a second public key and the encrypted purchase price sent by the demander and a third public key and the encrypted sale price sent by the supplier, the method further comprises:

sending a bargaining failure to the supplier corresponding to the encrypted sale price or the demander corresponding to the encrypted purchase price that does not meet the preset transaction conditions.

Preferably, sending a bargaining failure to the supplier corresponding to the encrypted sale price or the demander corresponding to the encrypted purchase price that does not meet the preset transaction conditions comprises:

when the demander dominates the transaction, sending a bargaining failure to the supplier corresponding to the encrypted sale price that does not meet the preset transaction conditions;

when the supplier dominates the transaction, sending a bargaining failure to the demander corresponding to the encrypted purchase price that does not meet the preset transaction conditions.

Preferably, the preset transaction conditions are as follows: the purchase price is less than the sale price, the difference between the sale price and the purchase price is less than a preset threshold, or the purchase price is greater than or equal to the sale price.

Preferably, the demander and the supplier obtain the pricing after corresponding decryption, comprising:

the demander decrypting the first encrypted pricing through the second private key corresponding to the second public key to obtain the pricing;

the supplier decrypting the second encrypted pricing through the third private key corresponding to the third public key to obtain the pricing.

The second aspect of the present application provides an automatic bargaining device based on smart contract and secure multi-party computation, comprising:

a generating module, which is configured to generate a first public key and a first private key based on a homomorphic encryption algorithm in the smart contract;

a first sending module, which is configured to send the first public key to a demander and a supplier so that the demander encrypts the purchase price through the first public key to obtain the encrypted purchase price, and the supplier encrypts the sale price through the first public key to obtain the encrypted sale price;

a decrypting module, which is configured to, after receiving a second public key and the encrypted purchase price sent by the demander and a third public key and the encrypted sale price sent by the supplier, decrypt the encrypted sale price and the encrypted purchase price that meet the preset transaction conditions based on the smart contract through the first private key to obtain the corresponding sale price and the purchase price;

an encryption module, which is configured to determine the pricing based on a preset pricing strategy of the smart contract, encrypt the pricing through the second public key to obtain a first encrypted pricing, and encrypt the pricing through the third public key to obtain a second encrypted pricing; and

a second sending module, which is configured to send the first encrypted pricing to the demander, and send the second encrypted pricing to the supplier, so that the demander and the supplier obtain the pricing after corresponding decryption.

Preferably, the automatic bargaining device further comprises:

a third sending module, which is configured to send a bargaining failure to the supplier corresponding to the encrypted sale price or the demander corresponding to the encrypted purchase price that does not meet the preset transaction conditions.

Preferably, the third sending module is specifically configured to:

when the demander dominates the transaction, send a bargaining failure to the supplier corresponding to the encrypted sale price that does not meet the preset transaction conditions;

when the supplier dominates the transaction, send a bargaining failure to the demander corresponding to the encrypted purchase price that does not meet the preset transaction conditions.

The third aspect of the present application provides an automatic bargaining device based on smart contract and secure multi-party computation, wherein the device comprises a processor and a memory;

the memory is configured to store a program code and transmit the program code to the processor;

the processor is configured to execute the automatic bargaining method based on smart contract and secure multi-party computation according to any one described in the first aspect in accordance with the instructions in the program code.

It can be seen from the above technical solutions that the present application has the following advantages.

The present application provides an automatic bargaining method based on smart contract and secure multi-party computation, comprising: generating a first public key and a first private key based on a homomorphic encryption algorithm in the smart contract; sending the first public key to a demander and a supplier so that the demander encrypts the purchase price through the first public key to obtain the encrypted purchase price, and the supplier encrypts the sale price through the first public key to obtain the encrypted sale price; after receiving a second public key and the encrypted purchase price sent by the demander and a third public key and the encrypted sale price sent by the supplier, decrypting the encrypted sale price and the encrypted purchase price that meet the preset transaction conditions based on the smart contract through the first private key to obtain the corresponding sale price and the purchase price; determining the pricing based on a preset pricing strategy of the smart contract, encrypting the pricing through the second public key to obtain a first encrypted pricing, and encrypting the pricing through the third public key to obtain a second encrypted pricing; and sending the first encrypted pricing to the demander, and sending the second encrypted pricing to the supplier, so that the demander and the supplier obtain the pricing after corresponding decryption.

The automatic bargaining method based on smart contract and secure multi-party computation in the present application encrypts the purchase price of the demander and the sale price of the supplier through the first public key randomly generated based on the homomorphic encryption algorithm in the smart contract for transmission, ensuring that the price data of both parties will not be known by the other party before the transaction is completed, and preventing the price data of both parties from being leaked; moreover, after receiving a second public key and the encrypted purchase price sent by the demander and a third public key and the encrypted sale price sent by the supplier, the encrypted sale price and the encrypted purchase price that meet the preset transaction conditions based on the smart contract are decrypted through the first private key, and then the pricing is determined. After the pricing is obtained, the pricing is encrypted through the second public key and the third public key. The first encrypted pricing and the second encrypted pricing obtained by encryption are sent to the corresponding demander and supplier, respectively. The data transmission in the entire process is performed in an encrypted environment. In combination with the decentralization function of the smart contract, the trust between the demander and the supplier can be guaranteed, avoiding the loss of the demander and the supplier due to the problems of a third-party institution, ensuring the security of data transmission, thereby solving the technical problem that the existing bargaining method is in lack of protecting the data privacy of both bargaining parties.

### BRIEF DESCRIPTION OF THE DRAWINGS

FIG. 1 is a schematic flowchart of an automatic bargaining method based on smart contract and secure multi-party computation according to an embodiment of the present application;

FIG. 2 is another flowchart of an automatic bargaining method based on smart contract and secure multi-party computation according to an embodiment of the present application;

FIG. 3 is a schematic structural diagram of an automatic bargaining device based on smart contract and secure multi-party computation according to an embodiment of the present application;

FIG. 4 is a schematic diagram of an automatic bargaining process according to an embodiment of the present application.

### DESCRIPTION OF THE EMBODIMENTS

In order to enable those skilled in the art to better understand the solutions of the present application, the technical solutions in the embodiments of the present application will be clearly and completely described hereinafter in conjunction with the drawings in the embodiments of the present application. Obviously, the described embodiments are only a part of the embodiments of the present application, rather than all of the embodiments. Based on the embodiments in the present application, all other embodiments obtained by those skilled in the art without creative work shall fall within the protection scope of the present application.

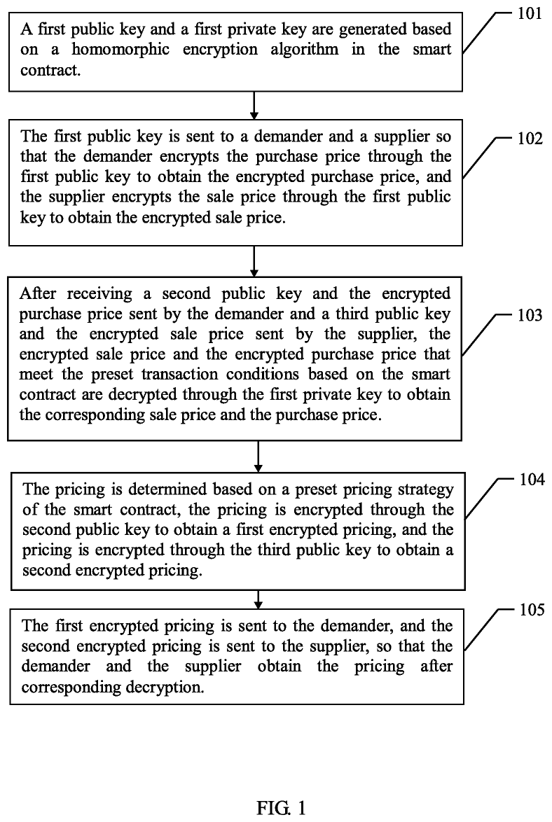

For ease of understanding, refer to FIG. 1. The present application provides an embodiment of an automatic bargaining method based on smart contract and secure multi-party computation, comprising the following steps.

Step 101: A first public key and a first private key are generated based on a homomorphic encryption algorithm in the smart contract.

It should be noted that a smart contract is a computer protocol that does not require an intermediary, performs verification by itself, and automatically executes the contract logic. The smart contract allows trusted transactions without a third party. These transactions are traceable and irreversible. secure multi-party computation is mainly studied in a multi-user network that does not trust each other, and securely performs collaborative calculation. That is, in a distributed network, each of a plurality of participants holds secret inputs, and all parties hope to jointly complete the calculation of a certain function. Each participant is required to be unable to obtain any input information from the user except the calculation result.

The homomorphic encryption algorithm comprises a secret key generation algorithm, an encryption algorithm and a decryption algorithm. The input of the secret key generation algorithm is a security parameter, and the output is a pair of secret keys (PK, SK), where PK is the public key and SK is the private key; the input of the encryption algorithm is the public key PK and the message m, and the output is the cipher text M; the input of the decryption algorithm is the private key SK and the cipher text M, and the output is the message m.

The homomorphic encryption algorithm in the embodiment of the present application can be the Paillier encryption algorithm. The Paillier encryption algorithm is an encryption algorithm with additive homomorphic properties. Its homomorphic characteristics are as follows: the cipher text can be directly subjected to corresponding arithmetic operations after encryption. The operation result is consistent with the corresponding operation result in the plaintext domain. That is, for any given x and y:

f(x*y)=f(x)·f(y);

where “*” is the operation of the plaintext, and “·” is the operation of the cipher text.

The selection process of the secret key is as follows: first, two large prime numbers p and q are randomly selected independently; secondly, n=pq is calculated, the least common multiple λ of p−1 and q−1 is taken, and the set of integers Zₙ_{²} less than n² and the set Z*ₙ_{²} of integers that are relatively prime to n² in Zₙ_{²} are determined. Then, an integer g is randomly selected and the sum is g∈gcd(L(g^{λ} mod n²), n), wherein L(g^{λ} mod n²)=(g^{λ}−1)/n², and gcd(·) is the function for calculating the greatest common divisor; finally, PK=(n, g) is selected as the public key and SK=λ is selected as the private key.

The contract can be written in the smart contract according to the logic of the Paillier encryption algorithm described above. The smart contract is a node deployed on the block chain. The node deployed on the block chain of the smart contract randomly selects the first public key and the first private key based on the Paillier encryption algorithm.

Since the existing bargaining method lacks sufficient protection for the data privacy of both parties and cannot be applied to the occasion of data protection, the Paillier encryption algorithm is used in the embodiment of the present application to ensure that the information of both parties during the bargaining process will not be stolen by the outside. Before the price is negotiated, the demander and the supplier will not know the information of the other party, but they you want to perform more complex processing when determining the final price, a third party is required to operate. The embodiment of the present application implements the pricing processing logic by introducing smart contract to realize the automatic execution of bargaining. Due to the decentralization of smart contract, the trust between the demander and the supplier can be guaranteed, avoiding the loss of the demander and the supplier due to the problems of a third-party institution, and ensuring the security of data transmission; and automatic bargaining is based on smart contract, which can reduce bargaining steps, improve bargaining efficiency, and save bargaining costs.

Step 102: The first public key is sent to a demander and a supplier so that the demander encrypts the purchase price through the first public key to obtain the encrypted purchase price, and the supplier encrypts the sale price through the first public key to obtain the encrypted sale price.

It should be noted that after the demander determines the purchase price and receives the first public key sent by the node, the purchase price is encrypted through the first public key to obtain the encrypted purchase price, and a public and private key pair containing a second public key and a second private key is generated. The encrypted purchase price and the second public key are then sent to the node where the smart contract is deployed; after the supplier determines the sale price and receives the first public key sent by the node, the sale price is encrypted through the first public key to obtain the encrypted sale price, and a public and private key pair containing a third public key and a second third key is generated. The encrypted sale price and the third public key are then sent to the node where the smart contract is deployed, ensuring that the price data of the demander and the supplier is not known to the other party, and there is no need to worry about the data being leaked.

Step 103: After receiving a second public key and the encrypted purchase price sent by the demander and a third public key and the encrypted sale price sent by the supplier, the encrypted sale price and the encrypted purchase price that meet the preset transaction conditions based on the smart contract are decrypted through the first private key to obtain the corresponding sale price and the purchase price.

It should be noted that after receiving the corresponding data, the node where the smart contract is deployed on the block chain will judge whether the purchase price of the demander and the sale price of the supplier meet the preset transaction conditions. The preset transaction conditions are also pre-written in the smart contract. Due to the homomorphic characteristics of the homomorphic encryption algorithm, that is, the encrypted purchase price and the encrypted sale price can be directly subjected to corresponding operations after encryption. The operation result is consistent with the corresponding operation result in the plaintext domain. The node calculates the encrypted purchase price and the encrypted sale price based on the rules in the smart contract, judges whether the encrypted purchase price and the encrypted sale price meet the preset transaction conditions according to the calculation results, and decrypts the encrypted sale price and the encrypted purchase price that meet the preset transaction conditions through the first private key to obtain the corresponding sale price and purchase price.

Step 104: The pricing is determined based on a preset pricing strategy of the smart contract, the pricing is encrypted through the second public key to obtain a first encrypted pricing, and the pricing is encrypted through the third public key to obtain a second encrypted pricing.

It should be noted that the preset pricing strategy is determined by the demander and the supplier and written in the smart contract. The node where the smart contract is deployed on the block chain determines the pricing according to the preset pricing strategy in the smart contract. The pricing is encrypted through the second public key to obtain a first encrypted pricing, and the pricing is encrypted through the third public key to obtain a second encrypted pricing.

Step 105: The first encrypted pricing is sent to the demander, and the second encrypted pricing is sent to the supplier, so that the demander and the supplier obtain the pricing after corresponding decryption.

It should be noted that the node sends the first encrypted pricing to the demander and sends the second encrypted pricing to the supplier. The first encrypted pricing can only be decrypted through the second private key of the demander, and the second encrypted pricing can only be decrypted through the third private key of the supplier, which effectively prevents data leakage and guarantees the privacy of the data; the price obtained by the demander and supplier after decryption is the final transaction price.

The automatic bargaining method based on smart contract and secure multi-party computation in the present application encrypts the purchase price of the demander and the sale price of the supplier through the first public key randomly generated based on the homomorphic encryption algorithm in the smart contract for transmission, ensuring that the price data of both parties will not be known by the other party before the transaction is completed, and preventing the price data of both parties from being leaked; moreover, after receiving a second public key and the encrypted purchase price sent by the demander and a third public key and the encrypted sale price sent by the supplier, the encrypted sale price and the encrypted purchase price that meet the preset transaction conditions based on the smart contract are decrypted through the first private key, and then the pricing is determined. After the pricing is obtained, the pricing is encrypted through the second public key and the third public key. The first encrypted pricing and the second encrypted pricing obtained by encryption are sent to the corresponding demander and supplier, respectively. The data transmission in the entire process is performed in an encrypted environment. In combination with the decentralization function of the smart contract, the trust between the demander and the supplier can be guaranteed, avoiding the loss of the demander and the supplier due to the problems of a third-party institution, ensuring the security of data transmission, thereby solving the technical problem that the existing bargaining method is in lack of protecting the data privacy of both bargaining parties.

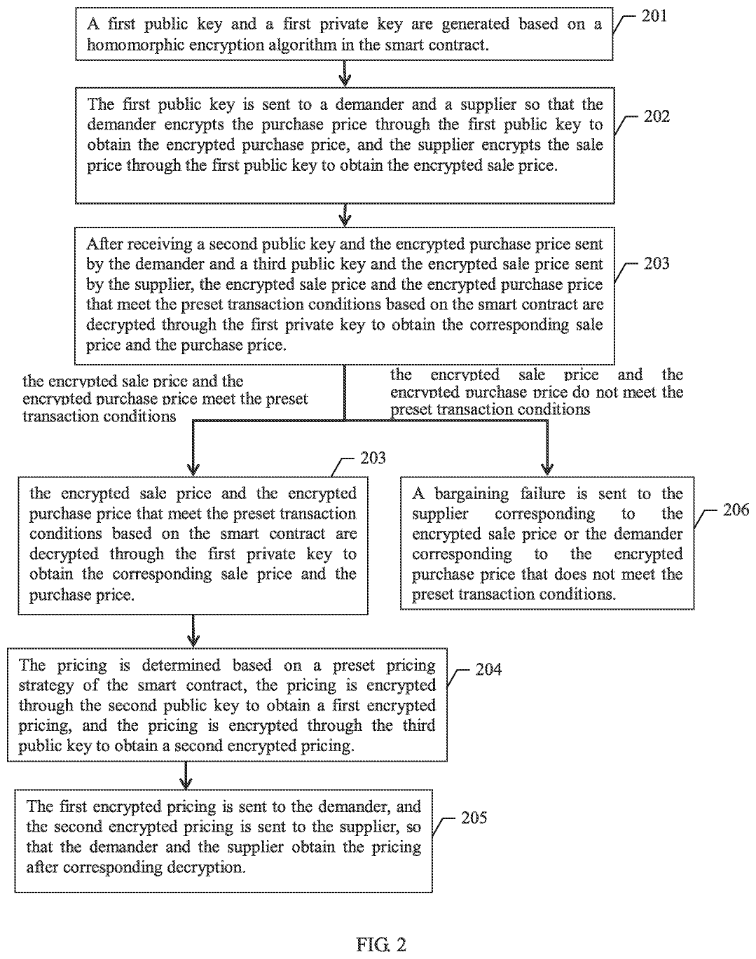

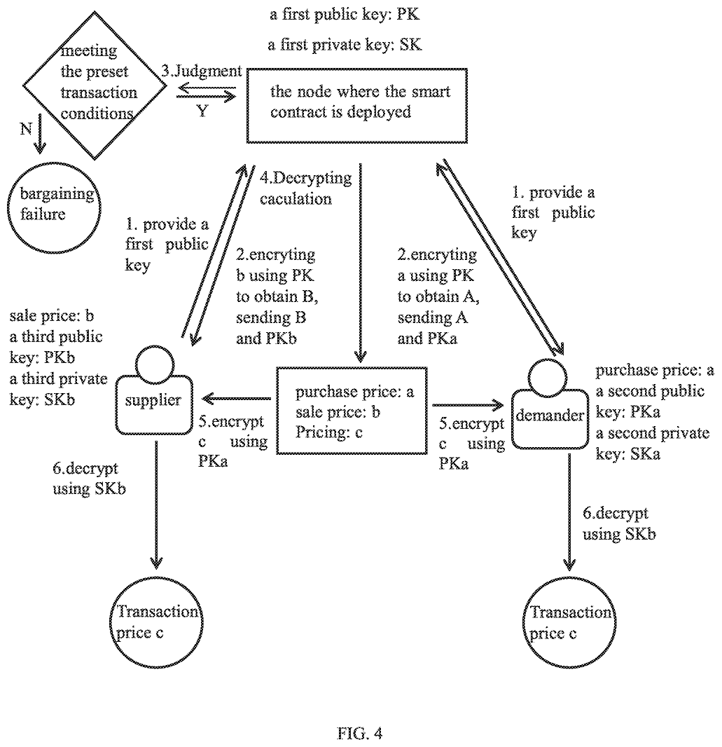

For ease of understanding, refer to FIGS. 2 and 4. The present application provides an embodiment of an automatic bargaining method based on smart contract and secure multi-party computation, comprising:

Step 201: A first public key and a first private key are generated based on a homomorphic encryption algorithm in the smart contract.

It should be noted that the node where the smart contract is deployed in the block chain generates the first public key PK and the first private key SK based on the homomorphic encryption algorithm in the smart contract.

Step 202: The first public key is sent to a demander and a supplier so that the demander encrypts the purchase price through the first public key to obtain the encrypted purchase price, and the supplier encrypts the sale price through the first public key to obtain the encrypted sale price.

It should be noted that the node provides the first public key to the demander and the supplier. After the demander determines the purchase price a, the purchase price a is encrypted by the first public key PK to obtain the encrypted purchase price A. The demander sends the second public key PKa in the generated second public key PKa and the second private key SKa and the encrypted purchase price A to the node; after the supplier determines the sale price b, the sale price is encrypted by the first public key PK to obtain encrypted sale price B, and the supplier sends the third public key PKb in the generated third public key PKb and the third private key SKb and the encrypted sale price B to the node.

Step 203: After receiving a second public key and the encrypted purchase price sent by the demander and a third public key and the encrypted sale price sent by the supplier, the encrypted sale price and the encrypted purchase price that meet the preset transaction conditions based on the smart contract are decrypted through the first private key to obtain the corresponding sale price and the purchase price.

It should be noted that after receiving the corresponding data, the node where the smart contract is deployed on the block chain will judge whether the purchase price of the demander and the sale price of the supplier meet the preset transaction conditions. The preset transaction conditions are also pre-written in the smart contract. The preset transaction conditions are as follows: the purchase price is less than the sale price, the difference between the sale price and the purchase price is less than a preset threshold, or the purchase price is greater than or equal to the sale price. That is, when the purchase price is greater than or equal to the sale price, the transaction conditions are met at this time; when the purchase price is less than the sale price, as long as the difference between the sale price and the purchase price is less than the preset threshold, the transaction conditions are also met at this time; when the purchase price is less than the sale price, and the difference between the sale price and the purchase price is greater than or equal to the preset threshold, the transaction conditions are not met at this time. Due to the homomorphic characteristics of the homomorphic encryption algorithm, that is, the encrypted purchase price and the encrypted sale price can be directly subjected to corresponding operations after encryption. The operation result is consistent with the operation result corresponding to the purchase price and the sale price in the plaintext domain. Therefore, the node can directly compare the encrypted purchase price and the encrypted sale price. When the encrypted purchase price is greater than or equal to the encrypted sale price, it is judged that the encrypted sale price and the encrypted purchase price meet the preset transaction conditions; when the encrypted purchase price is less than the encrypted sale price, the node further calculates the difference between the sale price and the purchase price, and compares the difference with the preset threshold. When the difference is less than the preset threshold, it is judged that the encrypted sale price and the encrypted purchase price meet the preset transaction conditions.

The encrypted sale price B and the encrypted purchase price A that meet the preset transaction conditions are then decrypted through the first private key SK to obtain the corresponding sale price b and the purchase price a.

Step 204: The pricing is determined based on a preset pricing strategy of the smart contract, the pricing is encrypted through the second public key to obtain a first encrypted pricing, and the pricing is encrypted through the third public key to obtain a second encrypted pricing.

It should be noted that the preset pricing strategy is determined by the demander and the supplier and written in the smart contract. The node where the smart contract is deployed on the block chain determines the pricing according to the preset pricing strategy in the smart contract, wherein the preset pricing strategy is as follows:

when the purchase price is less than the sale price and the difference between the sale price and the purchase price is less than a preset threshold, the pricing is as follows:

$$c = \frac{{m}_{1} a + {m}_{2} b}{{m}_{1} + {m}_{2}} ;$$

where a and b are the purchase price and the sale price, respectively, m₁ and m₂ are the weight coefficients of a and b, respectively, the values of m₁ and m₂ are determined by negotiation between the demander and the supplier, and c is the pricing;

when the purchase price is greater than or equal to the sale price and the demander dominates the transaction, the sale price is taken as the pricing, wherein the transaction situation corresponding to the demander dominating the transaction is one demander and a plurality of suppliers;

when the purchase price is greater than or equal to the sale price and the supplier dominates the transaction, the purchase price is taken as the pricing, wherein the transaction situation corresponding to the supplier dominating the transaction is one supplier and a plurality of demanders.

A plurality of pricing may be obtained through the preset pricing strategy. Taking the demander dominating the transaction as an example, when there is one demander and a plurality of suppliers, the purchase price of the demander may be greater than the sale price of one or more suppliers, and may be less than the sale price of another or more suppliers. The difference is less than the preset threshold. A plurality of pricing may be obtained at this time. The node needs to select the best supplier based on these pricing. At this time, the node can select the best supplier according to the principle of minimum pricing or according to the reputation, capacity, quality, etc. of each supplier.

Step 205: The first encrypted pricing is sent to the demander, and the second encrypted pricing is sent to the supplier, so that the demander and the supplier obtain the pricing after corresponding decryption.

It should be noted that when there are a plurality of pricing, taking the demander dominating the transaction and the principle of minimum pricing as an example, the node selects the smallest pricing based on the plurality of pricing obtained as the final pricing, the final pricing is encrypted through the second public key to obtain the first encrypted pricing, and the final pricing is encrypted through the third public key to obtain the second encrypted pricing. The first encrypted pricing is sent to the demander and the second encrypted pricing is sent to the corresponding supplier. The first encrypted pricing can only be decrypted through the second private key of the demander, and the second encrypted pricing can only be decrypted through the third private key of the supplier, which cannot be decrypted even if other suppliers receive the pricing, effectively preventing data leakage and guaranteeing the privacy of the data; the price obtained by the demander and supplier after decryption is the final transaction price.

Step 206: A bargaining failure is sent to the supplier corresponding to the encrypted sale price or the demander corresponding to the encrypted purchase price that does not meet the preset transaction conditions.

It should be noted that when the demander dominates the transaction, the node first judges the amount of the encrypted purchase price and the encrypted sale price. When the encrypted purchase price is less than the encrypted sale price, the node further calculates the difference between the encrypted sale price and the encrypted purchase price, and compares the difference with the preset threshold. When the difference is greater than or equal to the preset threshold, it is considered that the supplier corresponding to the encrypted sale price is maliciously bidding, it is judged that the encrypted sale price does not meet the preset transaction conditions, and the bargaining failure is sent to the supplier corresponding to the encrypted sale price.

When the supplier dominates the transaction, similarly, the node makes a judgment based on the encrypted purchase price and the encrypted sale price. When the encrypted purchase price is less than the encrypted sale price, and the difference between the encrypted sale price and the encrypted purchase price is greater than or equal to the preset threshold, it is considered that the demander corresponding to the encrypted purchase price is maliciously bidding, it is judged that the encrypted purchase price does not meet the preset transaction conditions, and the bargaining failure is sent to the demander corresponding to the encrypted purchase price. Even if bargaining fails, the price data will not be leaked.

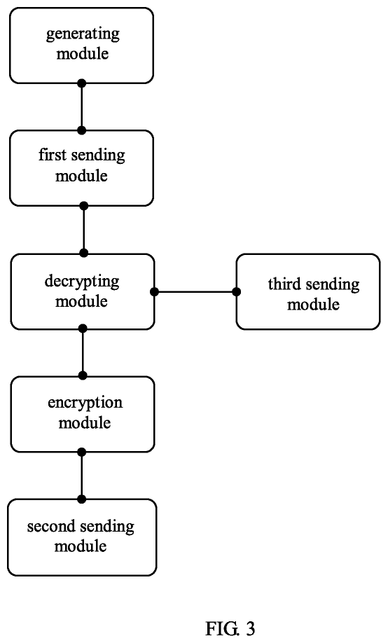

For ease of understanding, refer to FIG. 3. The present application provides an embodiment of an automatic bargaining device based on smart contract and secure multi-party computation according to the present application, comprising:

a generating module, which is configured to generate a first public key and a first private key based on a homomorphic encryption algorithm in the smart contract;

a first sending module, which is configured to send the first public key to a demander and a supplier so that the demander encrypts the purchase price through the first public key to obtain the encrypted purchase price, and the supplier encrypts the sale price through the first public key to obtain the encrypted sale price;

a decrypting module, which is configured to, after receiving a second public key and the encrypted purchase price sent by the demander and a third public key and the encrypted sale price sent by the supplier, decrypt the encrypted sale price and the encrypted purchase price that meet the preset transaction conditions based on the smart contract through the first private key to obtain the corresponding sale price and the purchase price;

an encryption module, which is configured to determine the pricing based on a preset pricing strategy of the smart contract, encrypt the pricing through the second public key to obtain a first encrypted pricing, and encrypt the pricing through the third public key to obtain a second encrypted pricing; and

a second sending module, which is configured to send the first encrypted pricing to the demander, and send the second encrypted pricing to the supplier, so that the demander and the supplier obtain the pricing after corresponding decryption.

Further, the automatic bargaining device further comprises:

a third sending module, which is configured to send a bargaining failure to the supplier corresponding to the encrypted sale price or the demander corresponding to the encrypted purchase price that does not meet the preset transaction conditions.

Further, the third sending module is specifically configured to:

when the demander dominates the transaction, send a bargaining failure to the supplier corresponding to the encrypted sale price that does not meet the preset transaction conditions;

when the supplier dominates the transaction, send a bargaining failure to the demander corresponding to the encrypted purchase price that does not meet the preset transaction conditions.

The embodiment of the present application further provides an automatic bargaining device based on smart contract and secure multi-party computation, wherein the device comprises a processor and a memory;

the memory is configured to store a program code and transmit the program code to the processor;

the processor is configured to execute the automatic bargaining method based on smart contract and secure multi-party computation in the embodiment of the automatic bargaining method based on smart contract and secure multi-party computation described above according to the instructions in the program code.

Those skilled in the art can clearly understand that, for the convenience and conciseness of description, the specific working process of the system, device, and unit described above may refer to the corresponding process in the method embodiment described above, which will not be described in detail here.

In the several embodiments provided in the present application, it should be understood that the disclosed device and method may be implemented in other manners. For example, the device embodiments described above are only illustrative. For example, the division of the units is only a logical function division, and there may be other division manners in actual implementation. For example, a plurality of units or components may be combined or may be integrated into another system, or some features may be ignored or not implemented. In addition, the displayed or discussed mutual coupling or direct coupling or communication connection may be indirect coupling or communication connection through some interfaces, devices or units, and may be in electrical, mechanical or other forms.

The units described as separate components may or may not be physically separated. The components displayed as units may or may not be physical units, that is, they may be located in one place, or they may be distributed on a plurality of network units. Some or all of the units may be selected according to actual needs to achieve the object of the solutions of the embodiments.

In addition, the functional units in each embodiment of the present application may be integrated into one processing unit, or each unit may exist alone physically, or two or more units may be integrated into one unit. The above integrated unit may be implemented in the form of hardware or a software functional unit.

If the integrated unit is implemented in the form of a software functional unit and sold or used as an independent product, it may be stored in a computer-readable storage medium. Based on this understanding, the technical solution of the present application essentially or the part that contributes to the prior art or all or part of the technical solution may be embodied in the form of a software product. The computer software product is stored in a storage medium, including several instructions to execute all or part of the steps of the methods described in the various embodiments of the present application through a computer device (which may be a personal computer, a server, or a network device, etc.). The above storage media comprise: various media that may store program codes, such as a USB flash disk, a mobile hard disk, a ROM (Read-Only Memory), a RAM (Random Access Memory), a magnetic disk or a compact disc.

As mentioned above, the above embodiments are only used to illustrate the technical solutions of the present application, rather than limit the technical solutions; although the present application has been described in detail with reference to the above embodiments, those skilled in the art should understand that: the technical solutions recorded in the embodiments can be modified, or some of the technical features can be equivalently replaced; these modifications or replacements do not cause the essence of the corresponding technical solutions to deviate from the spirit and scope of the technical solutions of the embodiments of the present application.

1. An automatic bargaining method based on smart contract and secure multi-party computation, comprising:
generating a first public key and a first private key based on a homomorphic encryption algorithm in the smart contract;
sending the first public key to a demander and a supplier so that the demander encrypts the purchase price through the first public key to obtain the encrypted purchase price, and the supplier encrypts the sale price through the first public key to obtain the encrypted sale price;
decrypting the encrypted sale price and the encrypted purchase price that meet the preset transaction conditions based on the smart contract through the first private key to obtain the corresponding sale price and the purchase price after receiving a second public key and the encrypted purchase price sent by the demander and a third public key and the encrypted sale price sent by the supplier;
determining the pricing based on a preset pricing strategy of the smart contract, encrypting the pricing through the second public key to obtain a first encrypted pricing, and encrypting the pricing through the third public key to obtain a second encrypted pricing; and
sending the first encrypted pricing to the demander, and sending the second encrypted pricing to the supplier, so that the demander and the supplier obtain the pricing after corresponding decryption.

2. The automatic bargaining method based on smart contract and secure multi-party computation according to claim 1, wherein the preset pricing strategy is as follows:
when the purchase price is less than the sale price and the difference between the sale price and the purchase price is less than a preset threshold, the pricing is as follows:
$$c = \frac{{m}_{1} a + {m}_{2} b}{{m}_{1} + {m}_{2}} ;$$
wherein a and b are the purchase price and the sale price, respectively, m₁ and m₂ are the weight coefficients of a and b, respectively, and c is the pricing;
when the purchase price is greater than or equal to the sale price and the demander dominates the transaction, the sale price is taken as the pricing, wherein the transaction situation corresponding to the demander dominating the transaction is one demander and a plurality of suppliers;
when the purchase price is greater than or equal to the sale price and the supplier dominates the transaction, the purchase price is taken as the pricing, wherein the transaction situation corresponding to the supplier dominating the transaction is one supplier and a plurality of demanders.

3. The automatic bargaining method based on smart contract and secure multi-party computation according to claim 2, wherein after receiving a second public key and the encrypted purchase price sent by the demander and a third public key and the encrypted sale price sent by the supplier, the method further comprises:
sending a bargaining failure to the supplier corresponding to the encrypted sale price or the demander corresponding to the encrypted purchase price that does not meet the preset transaction conditions.

4. The automatic bargaining method based on smart contract and secure multi-party computation according to claim 3, wherein sending a bargaining failure to the supplier corresponding to the encrypted sale price or the demander corresponding to the encrypted purchase price that does not meet the preset transaction conditions comprises:
when the demander dominates the transaction, sending a bargaining failure to the supplier corresponding to the encrypted sale price that does not meet the preset transaction conditions;
when the supplier dominates the transaction, sending a bargaining failure to the demander corresponding to the encrypted purchase price that does not meet the preset transaction conditions.

5. The automatic bargaining method based on smart contract and secure multi-party computation according to claim 1, wherein the preset transaction conditions are as follows: the purchase price is less than the sale price, the difference between the sale price and the purchase price is less than a preset threshold, or the purchase price is greater than or equal to the sale price.

6. The automatic bargaining method based on smart contract and secure multi-party computation according to claim 1, wherein the demander and the supplier obtain the pricing after corresponding decryption, comprising:
the demander decrypting the first encrypted pricing through the second private key corresponding to the second public key to obtain the pricing;
the supplier decrypting the second encrypted pricing through the third private key corresponding to the third public key to obtain the pricing.

7. An automatic bargaining device based on smart contract and secure multi-party computation, comprising:
a generating module, which is configured to generate a first public key and a first private key based on a homomorphic encryption algorithm in the smart contract;
a first sending module, which is configured to send the first public key to a demander and a supplier so that the demander encrypts the purchase price through the first public key to obtain the encrypted purchase price, and the supplier encrypts the sale price through the first public key to obtain the encrypted sale price;
a decrypting module, which is configured to, after receiving a second public key and the encrypted purchase price sent by the demander and a third public key and the encrypted sale price sent by the supplier, decrypt the encrypted sale price and the encrypted purchase price that meet the preset transaction conditions based on the smart contract through the first private key to obtain the corresponding sale price and the purchase price;
an encryption module, which is configured to determine the pricing based on a preset pricing strategy of the smart contract, encrypt the pricing through the second public key to obtain a first encrypted pricing, and encrypt the pricing through the third public key to obtain a second encrypted pricing; and
a second sending module, which is configured to send the first encrypted pricing to the demander, and send the second encrypted pricing to the supplier, so that the demander and the supplier obtain the pricing after corresponding decryption.

8. The automatic bargaining device based on smart contract and secure multi-party computation according to claim 7, further comprising:
a third sending module, which is configured to send a bargaining failure to the supplier corresponding to the encrypted sale price or the demander corresponding to the encrypted purchase price that does not meet the preset transaction conditions.

9. The automatic bargaining device based on smart contract and secure multi-party computation according to claim 8, wherein the third sending module is specifically configured to:
when the demander dominates the transaction, send a bargaining failure to the supplier corresponding to the encrypted sale price that does not meet the preset transaction conditions;
when the supplier dominates the transaction, send a bargaining failure to the demander corresponding to the encrypted purchase price that does not meet the preset transaction conditions.

10. An automatic bargaining device based on smart contract and secure multi-party computation, wherein the device comprises a processor and a memory;
the memory is configured to store a program code and transmit the program code to the processor;
the processor is configured to execute the automatic bargaining method based on smart contract and secure multi-party computation according to claim 1 in accordance with the instructions in the program code.
